(19) United States
(12) Patent Application Publication
(10) Pub. No.: US 2025/0005575 A1
(43) Pub. Date: Jan. 2, 2025

(54) PAYMENT METHODS AND APPARATUSES, AND PAY REQUEST PROCESSING METHODS AND APPARATUSES

(71) Applicant: Shanghai Ant Chuangjiang Information Technology Co., Ltd, Shanghai (CN)

(72) Inventors: Xiaolei Liu, Shanghai (CN); Fan Yang, Shanghai (CN); Yanping Gao, Shanghai (CN); Jinfeng Ji, Shanghai (CN); Jiangming Yang, Shanghai (CN)

(73) Assignee: Shanghai Ant Chuangjiang Information Technology Co., Ltd, Shanghai (CN)

(21) Appl. No.: 18/759,239

(22) Filed: Jun. 28, 2024

(30) Foreign Application Priority Data
Jun. 30, 2023 (CN) 202310801060.2

(51) Int. Cl. G06Q 20/40; G06Q 20/20; G06Q 20/36

(52) U.S. Cl. CPC G06Q 20/4014; G06Q 20/206; G06Q 20/36

(57) ABSTRACT

A payment method applied to a merchant client device, includes receiving a first instruction for selecting a first payment method for a first order on a first selection page by a target user. In an interface of a merchant client device, an account confirmation page of a first wallet corresponding to the first payment method is displayed. A confirmation instruction sent by the target user based on the account confirmation page is received. A checkout page of the first wallet is displayed in the interface of the merchant client device. Identity verification information entered by the target user based on the checkout page is received. A first payment result page is displayed, where the first payment result page comprises at least a payment result corresponding to the first order.

### CROSS-REFERENCE TO RELATED APPLICATIONS

This application claims priority to Chinese Patent Application No. 202310801060.2, filed on Jun. 30, 2023, which is hereby incorporated by reference in its entirety.

### TECHNICAL FIELD

One or more embodiments of this specification relate to the field of computer technologies, and in particular, to payment methods and apparatuses, and payment request processing methods and apparatuses.

### BACKGROUND

As more user payment behaviors such as overseas consumption payment occur online, a smooth and secure payment product is needed to provide a user with a better payment service, to effectively improve user experience.

### SUMMARY

Embodiments of this specification describe payment methods and apparatuses, and payment request processing methods and apparatuses, to create extremely simple and secure core experience for a user.

According to a first aspect, a payment method is provided, applied to a merchant client device, including: receiving a first instruction for selecting a first payment method for a first order on a first selection page by a target user; displaying, in an interface of the merchant client device, an account confirmation page of a first wallet corresponding to the first payment method; receiving a confirmation instruction sent by the target user based on the account confirmation page; displaying a checkout page of the first wallet in the interface of the merchant client device; receiving identity verification information entered by the target user based on the checkout page; and displaying a first payment result page, where the first payment result page includes at least a payment result corresponding to the first order.

In some embodiments, the merchant client device is installed in a target device, and an application client device of the first wallet is not installed in the target device.

In some embodiments, the account confirmation page and the checkout page are displayed in the interface of the merchant client device in a half page form by using a pop-up window or a floating layer.

In some embodiments, the account confirmation page and the checkout page each include a name and a design logo of the first wallet.

In some embodiments, the displaying an account confirmation page of a first wallet corresponding to the first payment method includes: displaying a pre-collected payment account of the first wallet on the account confirmation page; or displaying an account input box for the first wallet on the account confirmation page, to receive a payment account entered by the user based on the account input box.

In some embodiments, after the receiving identity verification information entered by the target user based on the checkout page, and before the displaying a first payment result page, the method further includes: displaying a secondary confirmation interface of the first wallet in the interface of the merchant client device; and receiving identity verification information entered by the user based on the secondary confirmation interface, where an identity verification manner corresponding to the secondary confirmation interface is different from an identity verification manner corresponding to the checkout page.

In some embodiments, the method further includes: receiving a second instruction sent by the target user based on the checkout page to instruct whether to subscribe to password-free payment.

In some embodiments, the second instruction instructs to subscribe to password-free payment, and the first payment result page further includes a subscription result for password-free payment.

In some specific embodiments, the subscription result indicates that subscription succeeds; and after the displaying a first payment result page, the method further includes: receiving a third instruction for selecting the first payment method for a second order on a second selection page by the target user; and displaying a second payment result page, where the second payment result page includes a payment result for the second order.

In some more specific embodiments, the second payment result page is a next display page of the second selection page.

In some embodiments, the second selection page includes a first selection area, the first payment method and a payment account of the first wallet are indicated in the first selection area, and the third instruction is sent by performing a triggering operation on the first selection area.

In some more specific embodiments, after the receiving a third instruction, and before the displaying a second payment result page, the method further includes: displaying a secondary confirmation interface of the first wallet in the interface of the merchant client device, where the secondary confirmation interface includes a to-be-paid amount corresponding to the second order, and the to-be-paid amount is greater than a corresponding threshold; and receiving a payment confirmation operation sent by the target user based on the secondary confirmation interface.

In some embodiments, the second instruction instructs not to subscribe to password-free payment; and after the displaying a first payment result page, the method further includes: displaying, in the interface of the merchant client device, a recommendation page of the first wallet for biometric identity verification payment; receiving a subscription instruction initiated by the user for biometric identity verification payment based on the recommendation page and biometric identity verification information; and displaying a subscription result page for biometric identity verification payment.

In some specific embodiments, it is indicated on the subscription result page that a subscription to biometric identity verification payment succeeds; and after the displaying a subscription result page for biometric identity verification payment, the method further includes: receiving a fourth instruction for selecting the first payment method for a third order on a third selection page by the target user; displaying a biometric identity verification page of the first wallet in the interface of the merchant client device, and receiving the biometric identity verification information entered by the user based on the biometric identity verification page; and displaying a third payment result page, where the third payment result page includes a payment result for the third order.

According to a second aspect, a payment request processing method is provided, applied to a merchant client device, and including: waking up, based on a first instruction for selecting a first payment method for a first order by a target user, a payment component integrated into the merchant client device, where the payment component is provided by an acquiring institution; invoking the payment component to obtain an account confirmation page of a first wallet corresponding to the first payment method; sending, by using the payment component, an order placement request to an acquiring server of the acquiring institution based on a confirmation instruction sent by the target user based on the account confirmation page, and receiving a fed-back order placement completion notification; invoking the payment component based on the order placement completion notification, to obtain a checkout page of the first wallet; and sending, by using the payment component, a service request to the acquiring server based on identity verification information entered by the target user on the checkout page, and receiving a fed-back processing result, where the processing result includes at least a payment result for the first order.

In one or more specific embodiments, the sending, by using the payment component, a service request to the acquiring server based on identity verification information entered by the target user on the checkout page includes: sending, by using the payment component, the service request to the acquiring server based on the identity verification information entered by the target user on the checkout page and a second instruction sent to instruct whether to subscribe to password-free payment.

In some specific embodiments, the second instruction instructs to subscribe to password-free payment, the service request includes a payment request and a subscription request, the processing result further includes a subscription success result, and the method further includes: obtaining a token issued by the first wallet for password-free payment.

In some more specific embodiments, the method further includes: sending, by using the payment component, the payment request to the acquiring server based on a third instruction for selecting the first payment method for a second order by the target user, and receiving a fed-back payment result, where the payment request carries the token.

In some other specific embodiments, the second instruction instructs not to subscribe to password-free payment, and the service request includes a payment request.

In some more specific embodiments, after the receiving a fed-back processing result, the method further includes: invoking the payment component, to obtain a recommendation page of the first wallet for biometric identity verification payment; and sending, by using the payment component, a biometric identity verification subscription request to the acquiring server based on a subscription instruction initiated by the target user for biometric identity verification payment on the recommendation page and entered biometric identity verification information, and receiving a fed-back subscription result.

Further, in an example, the subscription result indicates that a subscription to biometric identity verification payment succeeds; and after the receiving a fed-back subscription result, the method further includes: sending, by using the payment component, a payment request to the acquiring server based on a fourth instruction for selecting the first payment method for a third order by the target user, and receiving a fed-back identity verification need; invoking the payment component based on the identity verification need, to obtain a biometric identity verification page of the first wallet; and sending, to the acquiring server by using the payment component, the biometric identity verification information entered by the target user on the biometric identity verification page, and receiving a returned payment result.

According to a third aspect, a payment request processing method is provided, applied to an acquiring system. The acquiring system includes a payment component and an acquiring server, the payment component is integrated into a merchant client device, and the method includes:

The payment component provides an account confirmation page of a first wallet corresponding to a first payment method in response to a first instruction in the merchant client device. The first instruction is an instruction for selecting the first payment method for a first order by a target user. The payment component sends an order placement request to the acquiring server in response to a confirmation instruction sent by the target user based on the account confirmation page. The acquiring server interacts with a serving party of the first wallet based on the order placement request, to obtain an order placement completion notification, and forwards the order placement completion notification to the merchant client device by using the payment component, so that the merchant client device displays a checkout page of the first wallet. The payment component sends a service request to the acquiring server in response to identity verification information entered by the target user on the checkout page. The acquiring server interacts with the serving party of the first wallet based on the service request, to obtain a processing result, and forwards the processing result to the merchant client device by using the payment component. The processing result includes at least a payment result for the first order.

In some embodiments, that the payment component sends a service request to the acquiring server in response to identity verification information entered by the target user on the checkout page includes: The payment component sends the service request to the acquiring server in response to the identity verification information entered by the target user on the checkout page and a second instruction sent to instruct whether to subscribe to password-free payment.

In some embodiments, the second instruction instructs to subscribe to password-free payment, the service request includes a payment request and a subscription request, the processing result further includes a subscription success result, and the method further includes: The acquiring server forwards, to the merchant client device, a token issued by the first wallet for password-free payment.

In some specific embodiments, the method further includes: The payment component sends the payment request to the acquiring server in response to a third instruction in the merchant client device, and receives a fed-back payment result. The third instruction is an instruction for selecting the first payment method for a second order by the target user, and the payment request carries the token.

In some embodiments, the second instruction instructs not to subscribe to password-free payment, and the service request includes a payment request.

In some specific embodiments, after the acquiring server forwards the processing result to the merchant client device by using the payment component, the method further includes: The payment component provides a recommendation page of the first wallet for biometric identity verification payment. The payment component sends a biometric identity verification subscription request to the acquiring server in response to a subscription instruction initiated by the target user for biometric identity verification payment on the recommendation page and entered first biometric identity verification information. The acquiring server interacts with the serving party of the first wallet based on the biometric identity verification subscription request, to obtain a subscription result, and forwards the subscription result to the merchant client device by using the payment component.

In some more specific embodiments, the subscription result indicates that a subscription to biometric identity verification payment succeeds; and the method further includes: The payment component sends a payment request to the acquiring server in response to a fourth instruction in the merchant client device, and obtains a fed-back identity verification need. The fourth instruction is an instruction for selecting the first payment method for a third order by the target user. The payment component provides a biometric identity verification page of the first wallet based on the identity verification need, and sends, to the acquiring server, second identity verification information entered by the target user on the biometric identity verification page. The acquiring server interacts with the serving party of the first wallet based on the second biometric identity verification information, to obtain a payment result, and forwards the payment result to the merchant client device by using the payment component.

According to a fourth aspect, a payment apparatus is provided, integrated into a merchant client device, and including: a first receiving module, configured to receive a first instruction for selecting a first payment method for a first order on a first selection page by a target user; a first display module, configured to display, in an interface of the merchant client device, an account confirmation page of a first wallet corresponding to the first payment method; a second receiving module, configured to receive a confirmation instruction sent by the target user based on the account confirmation page; a second display module, configured to display a checkout page of the first wallet in the interface of the merchant client device; a third receiving module, configured to receive identity verification information entered by the target user based on the checkout page; and a third display module, configured to display a first payment result page, where the first payment result page includes at least a payment result corresponding to the first order.

According to a fifth aspect, a payment request processing apparatus is provided, integrated into a merchant client device, and including: a wakeup module, configured to wake up, based on a first instruction for selecting a first payment method for a first order by a target user, a payment component integrated into the merchant client device, where the payment component is provided by an acquiring institution; a first obtaining module, configured to invoke the payment component to obtain an account confirmation page of a first wallet corresponding to the first payment method; a first sending module, configured to: send, by using the payment component, an order placement request to an acquiring server of the acquiring institution based on a confirmation instruction sent by the target user based on the account confirmation page, and receive a fed-back order placement completion notification; a second obtaining module, configured to invoke the payment component based on the order placement completion notification, to obtain a checkout page of the first wallet; a second sending module, configured to send, by using the payment component, a service request to the acquiring server based on identity verification information entered by the target user on the checkout page; and a first receiving module, configured to receive a fed-back processing result, where the processing result includes at least a payment result for the first order.

According to a sixth aspect, an acquiring system is provided, configured to process a payment request. The acquiring system includes a payment component and an acquiring server, and the payment component is integrated into a merchant client device; the payment component is configured to provide an account confirmation page of a first wallet corresponding to a first payment method in response to a first instruction in the merchant client device, where the first instruction is an instruction for selecting the first payment method for a first order by a target user; the payment component is further configured to send an order placement request to the acquiring server in response to a confirmation instruction sent by the target user based on the account confirmation page; the acquiring server is configured to: interact with a serving party of the first wallet based on the order placement request, to obtain an order placement completion notification, and forward the order placement completion notification to the merchant client device by using the payment component, so that the merchant client device displays a checkout page of the first wallet; the payment component is further configured to send a service request to the acquiring server in response to identity verification information entered by the target user on the checkout page; and the acquiring server is further configured to: interact with the serving party of the first wallet based on the service request, to obtain a processing result, and forward the processing result to the merchant client device by using the payment component, where the processing result includes at least a payment result for the first order.

According to a seventh aspect, a computer-readable storage medium is provided. The computer-readable storage medium stores a computer program, and when the computer program is executed in a computer, the computer is enabled to perform the method according to the first aspect, the second aspect, or the third aspect.

According to an eighth aspect, a computing device is provided, including a memory and a processor. The memory stores executable code, and when the processor executes the executable code, the method according to the first aspect, the second aspect, or the third aspect is implemented.

According to the above-mentioned method and apparatus disclosed in the embodiments of this specification, a better payment service can be provided for a user, to create extremely simple and secure core experience.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following descriptions show merely some embodiments of this application, and a person of ordinary skill in the art can still derive other accompanying drawings from these accompanying drawings without creative efforts.

FIG. 1 is a schematic diagram illustrating a moving line existing when a user enables password-free payment, according to some embodiments of this specification;

FIG. 2 is a schematic diagram illustrating a moving line of performing secondary payment after a user enables password-free payment, according to some embodiments of this specification;

FIG. 3 is a schematic diagram illustrating a moving line existing when a user does not enable password-free payment, according to some embodiments of this specification;

FIG. 4 is a schematic diagram illustrating a moving line of performing secondary payment after a user does not enable password-free payment and enables biometric identity verification, according to some embodiments of this specification

FIG. 5 is a schematic flowchart of a payment method, according to some embodiments of this specification;

FIG. 6A is a schematic diagram illustrating a prototype of a payment method list page, according to some embodiments of this specification;

FIG. 6B is an example diagram illustrating a payment method list page, according to some embodiments of this specification;

FIG. 7A is a schematic diagram illustrating a prototype of an account confirmation page existing when a payment account is pre-collected, according to some embodiments of this specification;

FIG. 7B is an example diagram illustrating an account confirmation page existing when a payment account is pre-collected, according to some embodiments of this specification;

FIG. 8A is a schematic diagram illustrating a prototype of an account confirmation page when no payment account is pre-collected, according to some embodiments of this specification;

FIG. 8B is an example diagram illustrating an account confirmation page when no payment account is pre-collected, according to some embodiments of this specification;

FIG. 9A is a schematic diagram illustrating a prototype of a checkout page of a first wallet, according to some embodiments of this specification;

FIG. 9B is an example diagram illustrating a checkout page of a first wallet, according to some embodiments of this specification;

FIG. 10A is an example diagram 1 illustrating a first payment result page, according to some embodiments of this specification;

FIG. 10B is an example diagram 2 illustrating a first payment result page, according to some embodiments of this specification;

FIG. 11A is a schematic diagram illustrating switching of an interface of a merchant client device in a scenario in which no secondary confirmation needs to be performed in a case of password-free payment, according to some embodiments of this specification;

FIG. 11B is a schematic diagram illustrating switching of an interface of a merchant client device in a scenario in which secondary confirmation needs to be performed in a case of password-free payment, according to some embodiments of this specification;

FIG. 12 is an example diagram illustrating a recommendation page for biometric identity verification payment, according to some embodiments of this specification;

FIG. 13A is a schematic diagram illustrating switching of an interface of a merchant client device in a biometric identity verification payment scenario, according to some embodiments of this specification;

FIG. 13B is a partial schematic diagram illustrating switching of an interface of a merchant client device in a two-factor identity verification payment scenario, according to some embodiments of this specification;

FIG. 13C is another partial schematic diagram illustrating switching of an interface based on FIG. 13B, according to some embodiments of this specification;

FIG. 14 is a schematic diagram illustrating a multi-party interaction process of processing a payment request, according to some embodiments of this specification;

FIG. 15 is a schematic diagram illustrating a multi-party interaction process of performing payment after password-free payment is enabled, according to some embodiments of this specification;

FIG. 16 is a schematic diagram illustrating a multi-party interaction process of enabling biometric identity verification, according to some embodiments of this specification;

FIG. 17 is a schematic diagram illustrating a multi-party interaction process of performing payment after biometric identity verification is enabled, according to some embodiments of this specification;

FIG. 18 is a schematic structural diagram illustrating a payment apparatus, according to some embodiments of this specification;

FIG. 19 is a schematic structural diagram illustrating a payment request processing apparatus, according to some embodiments of this specification; and

FIG. 20 is a schematic structural diagram illustrating an acquiring system, according to some embodiments of this specification.

### DESCRIPTION OF EMBODIMENTS

The following describes the solutions provided in this specification with reference to the accompanying drawings.

As described above, more user payment behaviors occur online. It should be understood that payment disclosed in the embodiments of this specification is online payment. However, in many scenarios such as an overseas consumption scenario, a consumer usually gives up payment due to user experience. Examples are as follows:

(1) There is a need to jump to a third-party page: In a bank and wallet payment method, the customer can complete payment only after a jump is performed from a merchant side to a bank page to perform a series of complex identity authentication. A long payment path leads to a decrease in user payment willingness.

(2) A wallet app needs to be installed: In some electronic wallet payment methods, the user can complete payment only after installing the wallet app. Otherwise, the user is forcibly redirected to a wallet downloading page, and a payment procedure is interrupted.

(3) Phishing easily occurs: Due to a step of jumping to a third party, the user is very likely to be redirected to a phishing website, resulting in a financial loss of the user.

Based on the above-mentioned observation and analysis, the embodiments of this specification disclose a new payment product (or referred to as a payment solution), to provide a user with a better payment service.

Specifically, extremely simple and secure core experience is created in the payment solution. “Extremely simple” is reflected as follows: (1) There is no need to jump to a third-party page, and an overall procedure of the user is completed in a merchant client device (or briefly referred to as a merchant end). (2) After the user enables (or subscribes to) password-free payment, identity verification does not need to be performed again for secondary payment (any payment when password-free payment is in an enabled state). (3) In a scenario in which the user does not enable password-free payment, the user can enable biometric identity verification for security of subsequent payment.

“Secure” is reflected as follows: (1) A clear security guarantee text and a logo are exposed. (2) A shortcut unbinding portal and a text guidance are provided. (3) There is a secondary confirmation mechanism for a large-amount transaction.

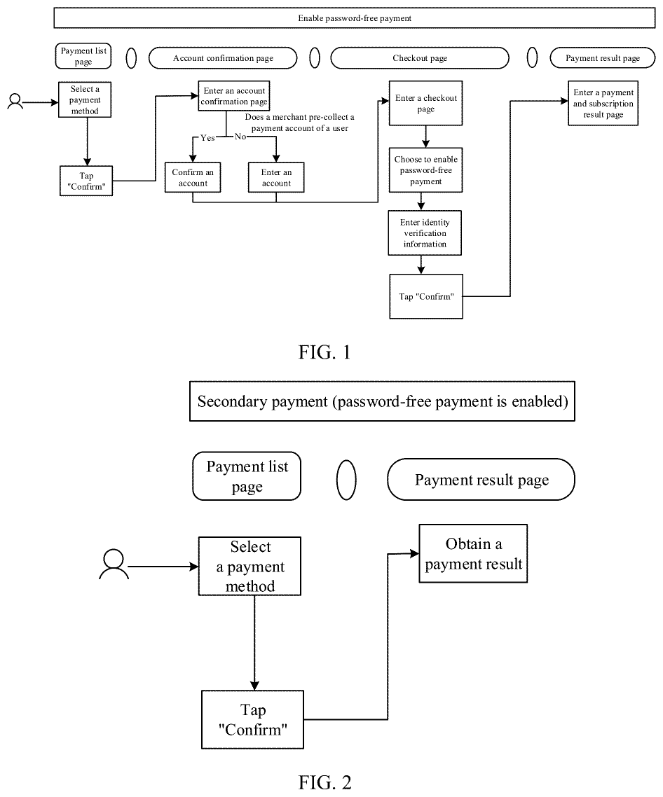

With reference to FIG. 1 to FIG. 4, the following first describes a user moving line mainly related to the above-mentioned payment solution.

FIG. 1 is a schematic diagram illustrating a moving line existing when a user enables password-free payment, according to some embodiments of this specification. As shown in FIG. 1, the user selects a payment method (for example, an electronic wallet) on a payment list page on a merchant end, and then taps “Confirm”. Then, the merchant end enters an account confirmation page. If a merchant pre-collects a payment account of the user, the user can directly perform a confirmation operation on a payment account displayed on the account confirmation page; otherwise, the user can enter an account in an input box on the account confirmation page. Further, the merchant end enters a checkout page provided by a serving party corresponding to the payment method. The user can choose to enable password-free payment on the checkout page, enter identity verification information, and provide confirmation. Then, a payment and subscription result page is entered. The payment and subscription result page displays a payment result and a subscription result for password-free payment.

FIG. 2 is a schematic diagram illustrating a moving line of performing secondary payment after a user enables password-free payment, according to some embodiments of this specification. If the user has enabled password-free payment in a previous time of payment, in subsequent payment, as shown in FIG. 2, after the user selects a payment method (password-free payment for the payment method is enabled) on a payment list page of a merchant end, and taps “Confirm”, a payment result page can be directly entered, without entering another page, to obtain a payment result displayed on the payment result page.

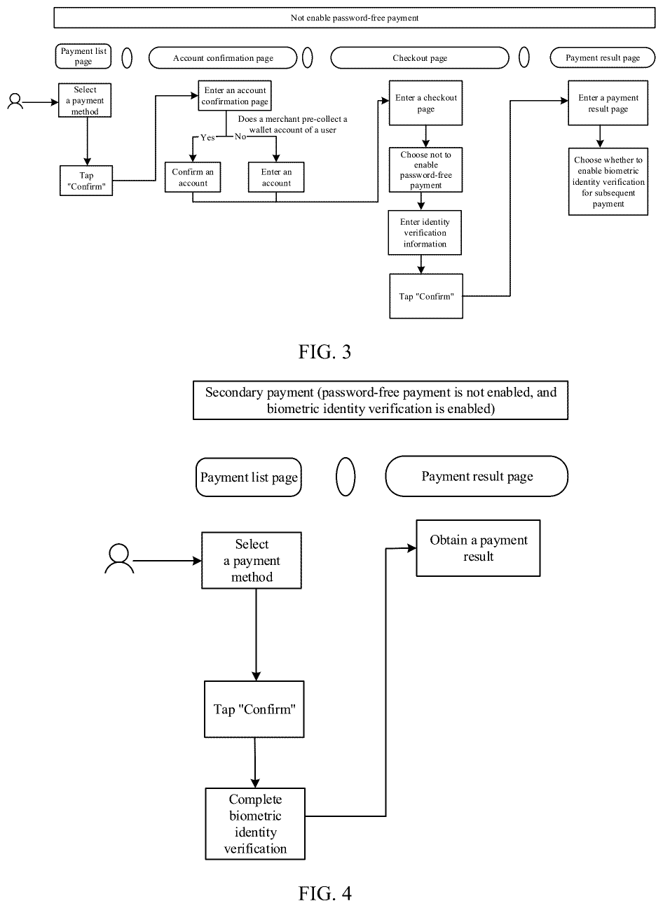

FIG. 3 is a schematic diagram illustrating a moving line existing when a user does not enable password-free payment, according to some embodiments of this specification. A difference between FIG. 3 and FIG. 1 lies in that, as shown in FIG. 3, after the user chooses not to enable password-free payment on a checkout page, and the user taps “Confirm” on the checkout page, a payment result page is entered, and no subscription result for password-free payment exists on the payment result page, and after the payment result page is entered, the user further sees recommendation information about enabling biometric identity verification, and the user can enable biometric identity verification under the guidance of the recommendation information, to perform subsequent payment.

FIG. 4 is a schematic diagram illustrating a moving line of performing secondary payment after a user does not enable password-free payment and enables biometric identity verification, according to some embodiments of this specification. If the user does not enable password-free payment but has enabled biometric identity verification, in subsequent payment, as shown in FIG. 4, after the user selects a payment method (biometric identity verification for the payment method is enabled) on a payment list page on a merchant end, and taps “Confirm”, biometric identity verification can be performed, and then a payment result page is entered, to obtain a payment result.

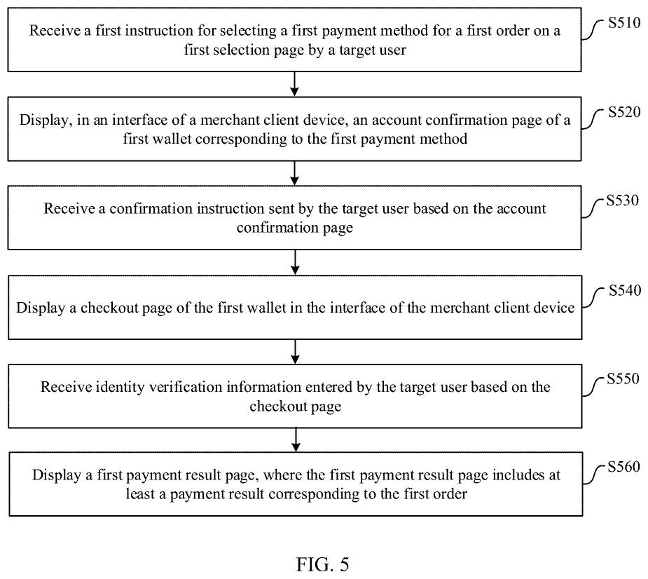

With reference to FIG. 5 and more embodiments, the following describes a process in which a user performs human-computer interaction with a merchant client device to experience a payment service, when the above-mentioned payment solution is used.

FIG. 5 is a schematic flowchart of a payment method, according to some embodiments of this specification. The payment method is applied to a merchant client device. It should be understood that the merchant client device can be a client device provided by any merchant (for example, an e-commerce platform). As shown in FIG. 5, the payment method includes the following steps.

Step S510: Receive a first instruction for selecting a first payment method for a first order on a first selection page by a target user. Step S520: Display, in an interface of the merchant client device, an account confirmation page of a first wallet corresponding to the first payment method. Step S530: Receive a confirmation instruction sent by the target user based on the account confirmation page. Step S540: Display a checkout page of the first wallet in the interface of the merchant client device. Step S550: Receive identity verification information entered by the target user based on the checkout page. Step S560: Display a first payment result page, where the first payment result page includes at least a payment result corresponding to the first order.

First, it is worthwhile to note that “first” in “first selection page”, “first order”, etc., “second” in “second instruction”, and a similar term in other descriptions in this specification are all intended to distinguish the same thing, and do not have another limitation function such as sorting.

The above-mentioned steps are elaborated as follows:

First, in step S510, the first instruction for selecting the first payment method for the first order on the first selection page by the target user is received.

It should be understood that, the target user can be any user who has registered an account in a merchant system. In this specification, a user of a current login account (or referred to as a first account) in the merchant client device is referred to as the target user. The merchant system includes the merchant client device and a merchant server.

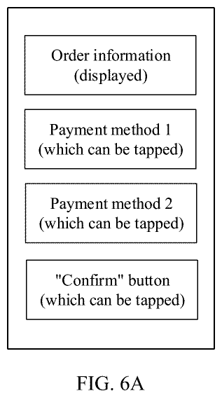

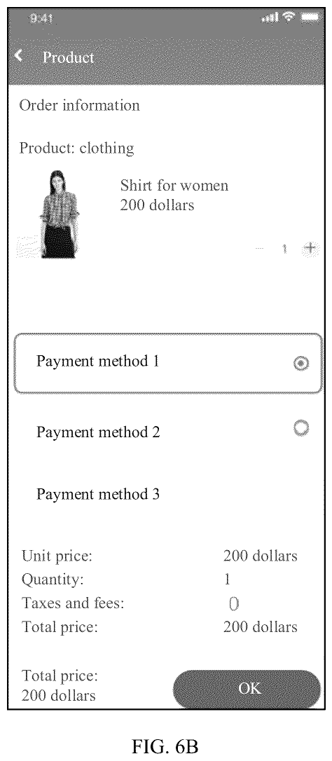

The first selection page (or the selection page is referred to as a payment method list page) is usually provided by a merchant, and displays a plurality of payment methods for selection by the user. For this, references can be made to FIG. 6A. A diagram of a prototype of the payment method list page shown in FIG. 6A displays a payment method 1 and a payment method 2. In addition, it should be understood that any payment method can be a bank card, an electronic wallet, etc. In a broad sense, each payment method can be considered as a wallet. For example, as shown in FIG. 6A, the payment method list page can further display order information, and include a “Confirm” button that can be tapped.

The first order is an order submitted by the target user in the merchant client device.

The first instruction can be a tap instruction for an icon of the first payment method on the first selection page. It should be understood that, in addition to a tap, a triggering manner of the first instruction can be another manner, for example, sound control. Triggering manners of all instructions are not limited in the some embodiments of this specification.

In an example, the first selection page is shown in FIG. 6B. Therefore, a selection operation and a confirmation operation that are performed by the target user for the payment method 1 of the first order (an order product is a shirt for women) can be received. It should be understood that, it can be considered that a combination of the two operations corresponds to the first instruction, or it can be considered that the confirmation operation corresponds to the first instruction.

As such, a confirmation and selection instruction of the target user for the first

payment method can be received.

Then, in step S520, the account confirmation page of the first wallet corresponding to the first payment method is displayed in the interface of the merchant client device.

In some embodiments, the target user logs in to the merchant client device by using the first account, and the first account is not a login account of the first wallet. In some other embodiments, the first account can alternatively be a login account of the first wallet. In other words, an account can be shared by a merchant side and a wallet side.

It is worthwhile to note that a service related to the first wallet is provided by a serving party of the first wallet instead of being provided by a merchant. Therefore, the account confirmation page is not provided by the merchant system either. In a conventional case, a user terminal jumps from a merchant end interface to an interface of a wallet client device of the first wallet, to perform a subsequent operation. However, in the some embodiments disclosed in this specification, it is designed that there is no need to jump to the interface of the wallet client device, and an overall procedure in which the target user pays the first order is completed on the merchant end. Actually, in a payment solution disclosed in the some embodiments of this specification, the user can successfully complete payment in the merchant client device even if an application client device of the first wallet is not installed (including “never installed”) in a target device in which the merchant client device is located.

Specifically, the account confirmation page is displayed in the interface of the merchant client device. For example, the account confirmation page is displayed in the interface of the merchant client device in a form of a pop-up window or a floating layer.

In addition, in some payment scenarios, a merchant and a wallet serving party use the same common account. However, in the some embodiments of this specification, in particular, in a scenario in which accounts of the merchant and the wallet serving party are independent of each other, the first account that is currently logged in to in the merchant client device cannot be used as the login account of the first wallet.

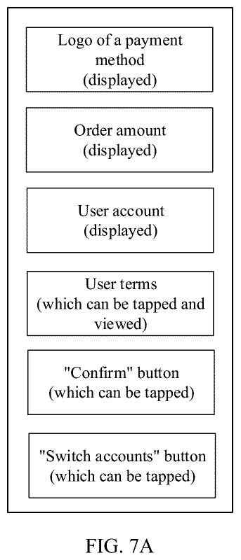

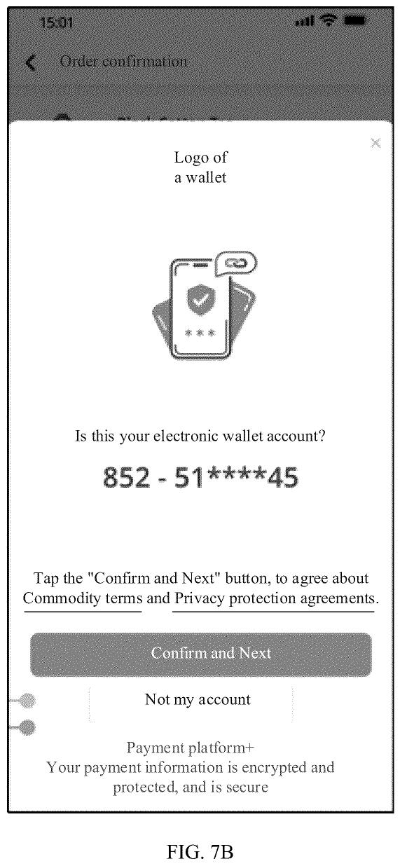

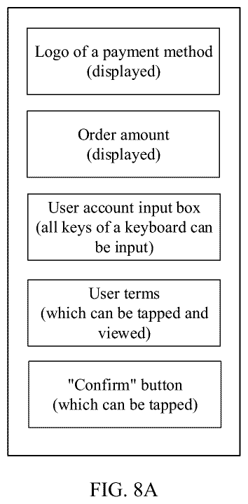

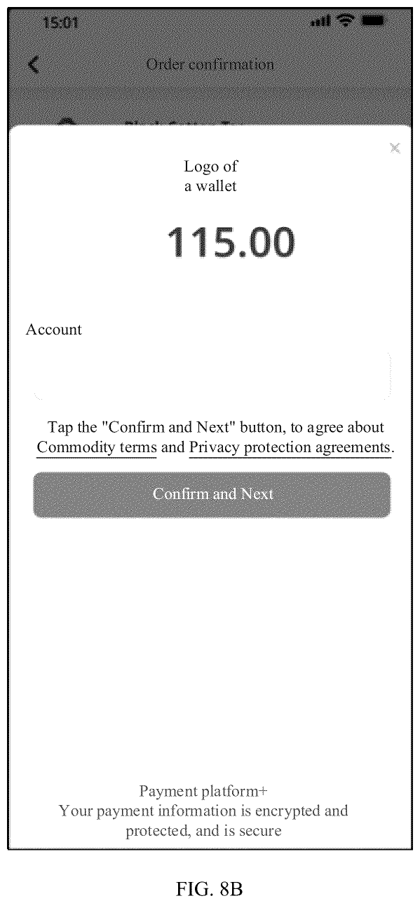

The following describes content of the account confirmation page with reference to FIG. 7A, FIG. 7B, FIG. 8A, and FIG. 8B. FIG. 7A is a schematic diagram illustrating a prototype of an account confirmation page existing when a payment account is pre-collected, according to some embodiments of this specification. The account confirmation page includes a payment account (shown as a user account in FIG. 7A) that is for the first wallet and that is pre-collected by the merchant. It should be understood that how the merchant collects the payment account is not limited, but the payment account needs to be collected when the user determines to grant authorization. Therefore, if the user determines that the displayed payment account is correct, the user can directly tap a “Confirm” button, or if the user determines that the payment account is incorrect, the user can tap a “Switch accounts” button to enter an account independently. FIG. 7B is an example diagram corresponding to FIG. 7A.

FIG. 8A is a schematic diagram illustrating a prototype of an account confirmation page when no payment account is pre-collected, according to some embodiments of this specification. The account confirmation page includes a user account input box, so that the user enters a payment account of the user in the first wallet. FIG. 8B is an example diagram corresponding to FIG. 8A.

In addition, as shown in FIG. 7A and FIG. 8A, the account confirmation page can further include a logo of a payment method or a logo of the first wallet, to help the user identify validity of the page, and can further include an order amount, user terms that can be tapped and viewed, etc. In view of this, references can be further made to FIG. 7B and FIG. 8B. It can be seen that FIG. 7B and FIG. 8B further display a text “Your payment information is encrypted and protected, and is secure”.

The account confirmation page displayed in the merchant end interface is mainly described above.

Then, in step S530, the confirmation instruction sent by the target user based on the account confirmation page is received. For example, a tap operation performed by the target user on a “Confirm and Next” button on the account confirmation page shown in FIG. 7B or FIG. 8B can be received.

Then, in step S540, the checkout page of the first wallet is displayed in the interface of the merchant client device, and in step S550, the identity verification information entered by the target user based on the checkout page is received. It is worthwhile to note that the checkout page can be designed to simultaneously receive, in this step, a second instruction sent by the target user to instruct whether to subscribe to password-free payment, or can be designed not to include related information such as a button for enabling password-free payment. In this case, in step S550, only user identity verification information is received.

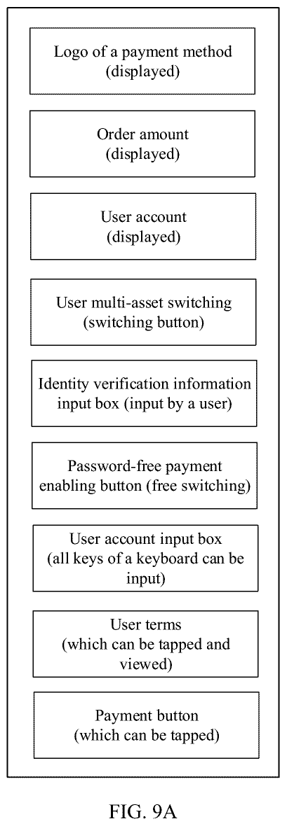

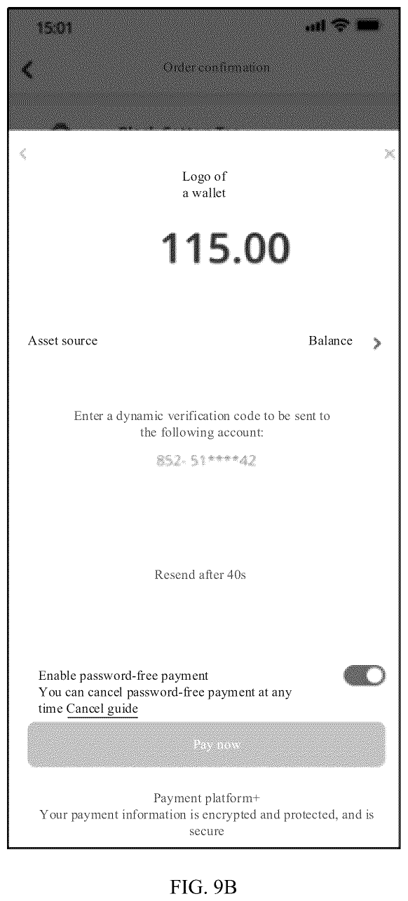

In some embodiments, the checkout page is displayed in the interface of the merchant client device in a half page form by using a pop-up window or a floating layer. For example, the checkout page shown in FIG. 9B is displayed in the interface of the merchant client device in a half page form by using a floating layer.

In some embodiments, the checkout page includes an identity verification information input box. For this, references can be made to a diagram illustrating a prototype of the checkout page shown in FIG. 9A. Therefore, identity verification information entered by the user in the input box can be received. It should be understood that the checkout page can further include an identity verification information input icon in another form, to guide the user to enter the identity verification information. For example, the identity verification information can be in a plurality of forms such as a one-time password (OTP), a personal identification number (PIN), face scanning, a fingerprint, and an acoustic wave. The OTP can also be referred to as a dynamic verification code.

In some embodiments, the checkout page includes a password-free payment enabling button, and therefore, can receive a second instruction sent by the user based on the password-free payment enabling button to instruct whether to subscribe to password-free payment. Usually, the password-free payment enabling button in a default state indicates “not enabled”, and is switched to indicate “enabled” after the user taps the password-free payment enabling button.

In some embodiments, as shown in FIG. 9A, the checkout page can further include a logo of a payment method, an order amount, a payment account, a user multi-asset switching button, user terms that can be tapped and viewed, and a payment button that can be tapped. It should be understood that a plurality of types of assets (for example, a user balance, a credit card, and a deposit card) can be attached to some wallets. In this case, the target user can select assets for payment by using the multi-asset switching button.

In an example, a dynamic verification code entered by the user based on the checkout page shown in FIG. 9B and an enabling instruction sent to instruct to subscribe to password-free payment can be received.

As such, the identity verification information entered by the target user on the checkout page and the second instruction sent to instruct whether to subscribe to password-free payment can be received.

Then, in step S560, the first payment result page is displayed. The first payment result page includes at least the payment result corresponding to the first order.

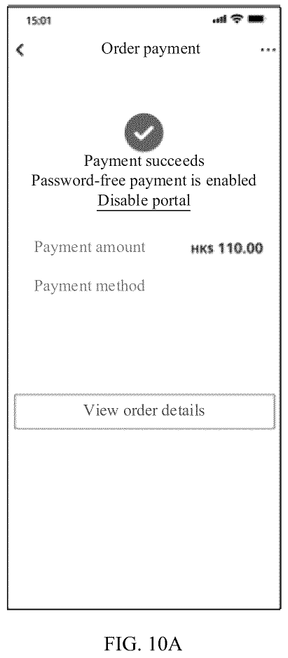

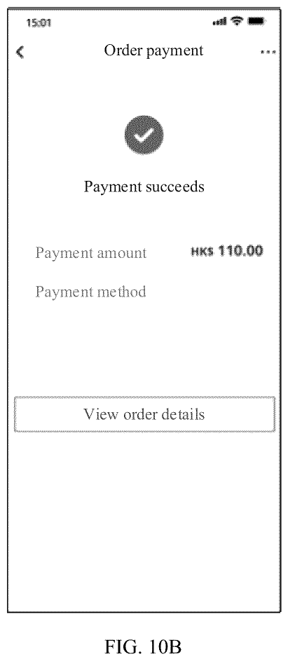

In an implementation case A, the second instruction instructs to subscribe to password-free payment. In this case, the payment result page further includes a subscription result for password-free payment. For example, the first payment result page shown in FIG. 10A includes a payment result (for example, a payment success and a payment amount) and a subscription result (for example, a subscription success).

Further, when the subscription result indicates that a subscription to password-free payment succeeds, the payment method can further include: receiving a third instruction for selecting the first payment method for a second order on a second selection page by the target user; and displaying a second payment result page, where the second payment result page includes a payment result for the second order.

It can be understood that the second order is different from the first order. In some embodiments, the second selection page includes a first selection area, the first payment method and a payment account of the first wallet are indicated in the first selection area, and the third instruction is sent by performing a triggering operation on the first selection area.

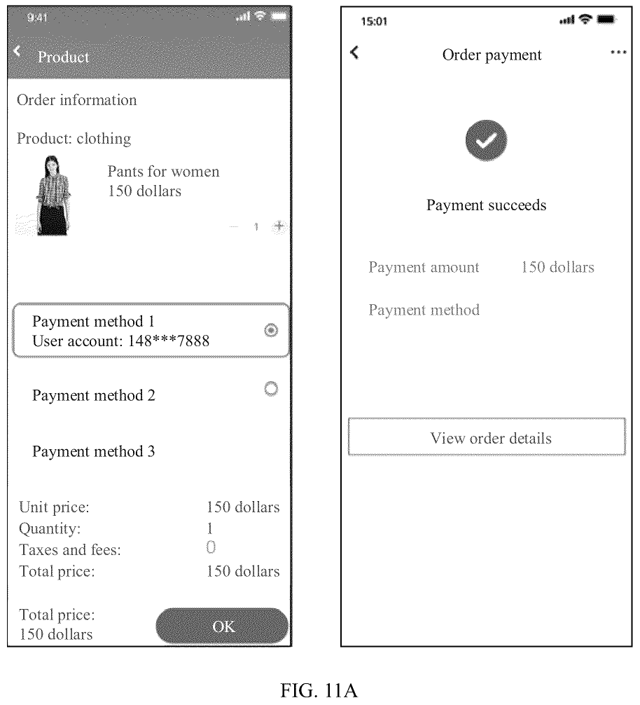

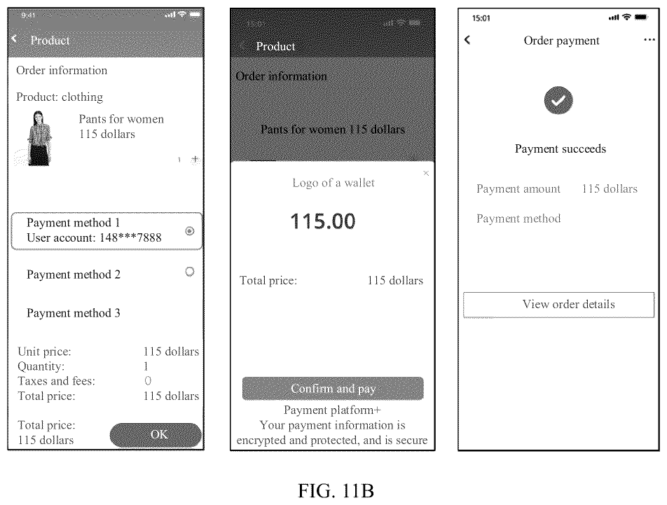

Further, in some embodiments, the second payment result page is a next display page of the second selection page. For this, references can be made to FIG. 11A. FIG. 11A is a schematic diagram illustrating switching of an interface of a merchant client device when no secondary confirmation needs to be performed in a case of password-free payment.

In some other embodiments, it is designed that secondary confirmation needs to be performed in a case of large-amount payment, to improve protection for user fund security. Specifically, after the receiving a third instruction, and before the displaying a second payment result page, the method further includes: displaying a secondary confirmation interface of the first wallet in the interface of the merchant client device, where the secondary confirmation interface includes a to-be-paid amount corresponding to the second order; and receiving a payment confirmation operation sent by the target user based on the secondary confirmation interface. It should be understood that, when a user security consideration or a transaction risk occurs in a direct debit transaction, secondary confirmation or identity verification can be provided. For example, when the to-be-paid amount is greater than a corresponding threshold, it is considered that there is a transaction risk. The threshold can be set by a serving party of the first wallet (for example, set based on a daily consumption amount of the user), or can be customized by the user.

For example, references can be made to FIG. 11B. FIG. 11B shows an example of switching of an interface of a merchant client device when secondary confirmation needs to be performed in a case of password-free payment.

As such, secondary payment when the subscription to password-free payment succeeds can be completed.

When the subscription result indicates that the subscription to password-free payment fails, the subscription result can further include a reason for a subscription failure. For example, a password-free payment button can be displayed on the first payment result page, to guide the user to attempt again to enable password-free payment.

The implementation case A is described above. In this implementation case, the second instruction instructs to subscribe to password-free payment.

In an implementation case B, the second instruction instructs not to enable password-free payment. In this case, the first payment result page does not include a subscription result. For example, the first payment result page shown in FIG. 10B includes only a payment result.

Further, in some embodiments, the user can be guided to enable biometric identity verification for subsequent payment. Specifically, the payment method further includes: displaying, in the interface of the merchant client device, a recommendation page of the first wallet for biometric identity verification payment; receiving a subscription instruction initiated by the user for biometric identity verification payment based on the recommendation page and biometric identity verification information; and displaying a subscription result page for biometric identity verification payment.

Further, in some specific embodiments, it is indicated on the subscription result page that a subscription to biometric identity verification payment succeeds. In this case, a subsequent secondary payment process can include: receiving a fourth instruction for selecting the first payment method for a third order on a third selection page by the target user; displaying a biometric identity verification page of the first wallet in the interface of the merchant client device, and receiving the biometric identity verification information entered by the user based on the biometric identity verification page; and displaying a third payment result page, where the third payment result page includes a payment result for the third order.

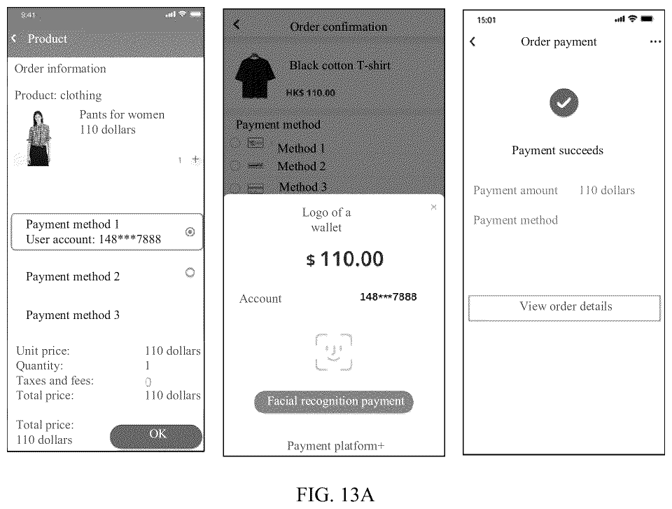

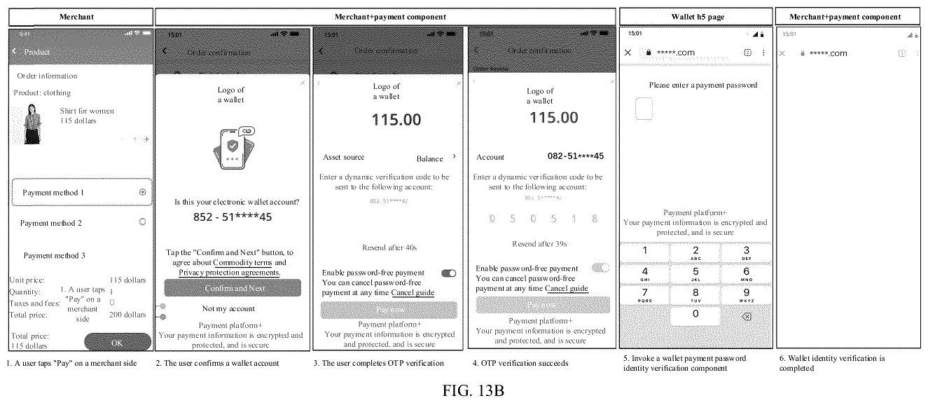

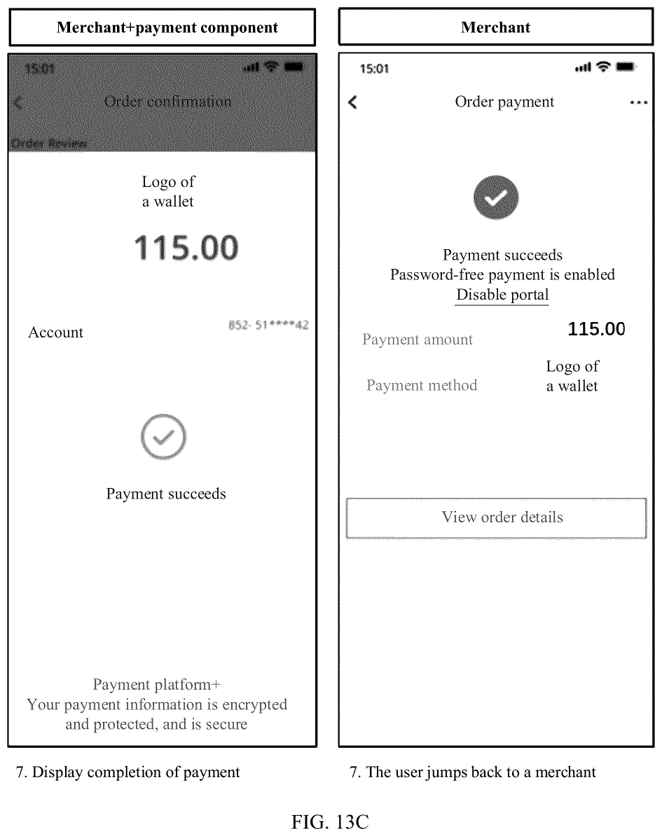

For example, references can be made to FIG. 13A. FIG. 13A shows an example of switching of an interface of a merchant client device in a biometric identity verification payment scenario.

It is worthwhile to note that if the target user does not choose to enable biometric identity verification on the recommendation page for biometric identity verification payment, biometric identity verification can be recommended again during subsequent payment, and until a predetermined recommendation quantity threshold (for example, three times) is reached, biometric identity verification is no longer recommended to the user. In addition, actually, in the above-mentioned scenario in which enabling of password-free payment fails, the user can also be recommended to enable biometric identity verification.

Displaying the first payment result page in this step and some subsequent possible steps are described above. According to some embodiments of another aspect, after step S550 and before this step (S560), the target user can be required to perform secondary identity verification. It should be understood that secondary identity verification usually occurs in a high risk scenario. Specifically, the secondary confirmation interface of the first wallet is displayed in the interface of the merchant client device, and then identity verification information entered by the user based on the secondary confirmation interface is received. Usually, an identity verification manner corresponding to the secondary confirmation interface is different from an identity verification manner corresponding to the checkout page.

For example, FIG. 13B is a partial schematic diagram illustrating switching of an interface of a merchant client device in a two-factor identity verification payment scenario, according to some embodiments of this specification. FIG. 13B shows that the identity verification manner of the checkout page is an OTP, and the identity verification manner of the secondary confirmation page is entering a payment password. FIG. 13B shows six pages sequentially displayed to the user on the merchant end. The user can select a payment method on a payment method list page ranked the first. The user can confirm a wallet account on an account confirmation page ranked the second. The user can complete OTP verification on a checkout page ranked the third. On the fourth page, it is sensed that OTP verification succeeds, and then identity verification is performed again. Specifically, the payment password is entered on a wallet h5 page obtained by invoking a wallet payment password identity verification component, and it is sensed on a subsequent page that wallet identity verification is completed.

Further, after the sixth page, other pages shown in FIG. 13C can be further displayed through switching, to view a payment result and return to a merchant page.

In conclusion, according to the payment method disclosed in the some embodiments of this specification, a better payment service can be provided for the user, to create extremely simple and secure user experience.

The process in which the user performs human-computer interaction with the merchant client device to experience the payment service, when the payment solution disclosed in the embodiments of this specification is used is described above. The following describes interaction links between a user, a merchant client device, and an acquiring system related to the payment solution. It should be understood that the acquiring system includes a payment component and an acquiring server. The payment component is integrated into the merchant client device. For example, the payment component can be implemented as a software development kit (SDK).

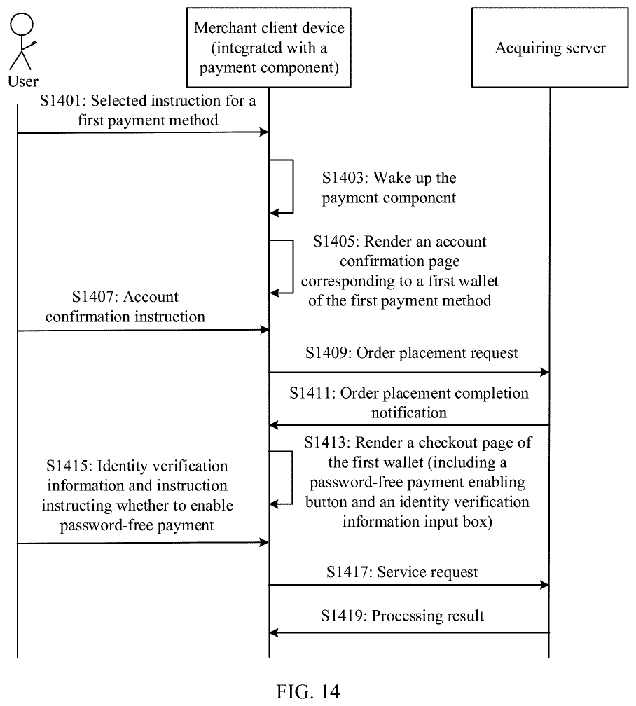

FIG. 14 is a schematic diagram illustrating a multi-party interaction process of processing a payment request, according to some embodiments of this specification. As shown in FIG. 14, a plurality of parties include a target user, a merchant client device, and an acquiring system, and a shown interaction process includes the following steps.

Step S1401: The merchant client device receives a first instruction for selecting a first payment method for a first order by the target user.

In some embodiments, the first instruction is sent based on a first selection page. For example, for the first selection page, references can be made to FIG. 6B.

Step S1403: The merchant client device wakes up, based on the first instruction, a payment component integrated into the payment component.

It should be understood that, in a conventional case, the merchant client device needs to interact with different servers provided by different wallet serving parties. In the some embodiments disclosed in this specification, the merchant client device does not need to interact with any wallet server, but only needs to invoke the payment component to interact with an acquiring server. In this way, development difficulty and communication burden of the merchant client device can be greatly reduced.

In addition, the payment component can be invoked for another operation only after the payment component is woken up.

Step S1405: The merchant client device invokes the payment component, to obtain an account confirmation page of a first wallet corresponding to the first payment method.

Specifically, the merchant client device can invoke the payment component to render the account confirmation page. In some embodiments, the merchant client device can send, to the payment component, a payment account that is for the first wallet and that is pre-collected by a merchant system, so that the payment account is directly displayed on the account confirmation page for confirmation by the user. For example, references can be made to the account confirmation page shown in FIG. 7B.

In some other embodiments, the payment component does not obtain a pre-collected payment situation. In this case, the account confirmation page includes an account input box, so that the user enters a payment account. For example, references can be made to the account confirmation page shown in FIG. 8B.

Step S1407: The merchant client device receives a confirmation instruction sent by the target user based on the account confirmation page. For example, a tap operation performed by the target user on a “Confirm and Next” button on the account confirmation page shown in FIG. 7B or FIG. 8B can be received.

Step S1409: The merchant client device sends an order placement request to the acquiring server by using the payment component.

For example, the order placement request can be generated by the payment component, and include a payment account of a first wallet confirmed by the user.

Step S1411: The acquiring server sends an order placement completion notification to the merchant client device by using the payment component, where the order placement completion notification is obtained by the acquiring server by interacting with a serving party of the first wallet based on the order placement request.

It should be understood that there are a plurality of manners in which the acquiring server interacts with the serving party of the first wallet based on the order placement request, and the manners can be designed based on an actual situation. For example, after parsing the order placement request, the acquiring server can send, to a server of the first wallet, the payment account included in the order placement request, so that the server verifies availability of the payment account, and generates the order placement completion notification when receiving a verification result indicating that the payment account is available. Further, the order placement completion notification can further include a plurality of types of available assets (for example, a credit card, a balance, and a deposit card) of the target user in the payment account.

Step S1413: The merchant client device invokes the payment component based on the order placement completion notification, to obtain a checkout page of the first wallet. For example, references can be made to the checkout page shown in FIG. 9B.

Step S1415: The merchant client device receives identity verification information entered by the target user on the checkout page and a second instruction sent to instruct whether to subscribe to password-free payment.

It is worthwhile to note that, for descriptions of step S1415, references can be made to related descriptions of step S550. Details are omitted.

Step S1417: The merchant client device sends a service request to the acquiring server by using the payment component.

For example, the payment component can generate the service request based on the identity verification information and the second instruction.

In some embodiments, the second instruction instructs to subscribe to password-free payment. Correspondingly, the service request includes a payment request and a subscription request. In some other embodiments, the second instruction instructs not to subscribe to password-free payment. Correspondingly, the service request can include a payment request but does not a subscription request.

Step S1419: The acquiring server sends a processing result to the merchant client device by using the payment component, where the processing result is obtained by the acquiring server by interacting with the serving party of the first wallet based on the service request, and the processing result includes at least a payment result for the first order.

It should be understood that there are a plurality of manners in which the acquiring server interacts with the serving party of the first wallet based on the service request to obtain the processing result. The manners can be specifically designed based on a need. For example, the acquiring server forwards the service request to the server of the first wallet. After processing the service request, the server returns the processing result to the acquiring server.

In some embodiments, the service request includes the payment request and the subscription request. In this case, the processing result includes a payment result corresponding to the payment request and a subscription result corresponding to the subscription request. In some specific embodiments, the acquiring server can further send, to the merchant client device by using the payment component, a token issued by the first wallet for password-free payment. The merchant client device can locally store a login account of the target user in a merchant and the token in an association manner, or can upload the token to the merchant server. It can be understood that the token is issued only when a subscription succeeds.

In some other embodiments, the service request includes the payment request but does not include the subscription request. In this case, the processing result includes a payment result but does not include a subscription result.

Further, the merchant client device can display the processing result on a first payment result page. For example, the first payment result page can be generated by the merchant client device without a need to invoke the payment component. In addition, references can be made to the first payment result page shown in FIG. 10A or FIG. 10B.

As such, the user can choose to enable password-free payment, or can choose not to enable password-free payment.

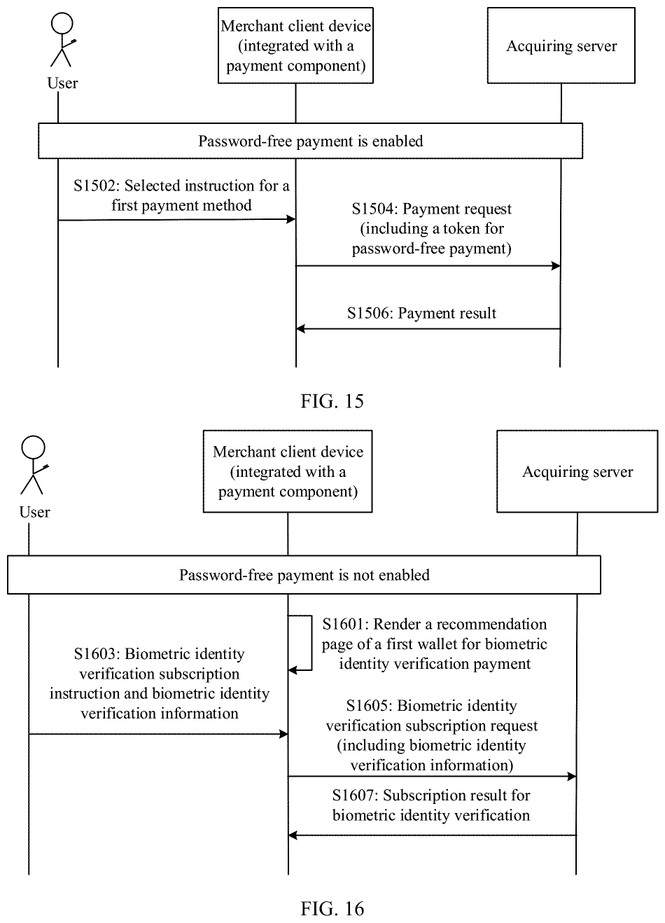

According to some embodiments of another aspect, the above-mentioned multi-party interaction process further includes interaction steps of subsequently performing payment when the target user successfully enables password-free payment. FIG. 15 is a schematic diagram illustrating a multi-party interaction process of performing payment after password-free payment is enabled, according to some embodiments of this specification. As shown in FIG. 15, secondary payment after password-free payment is enabled includes the following steps.

Step S1502: The merchant client device receives a third instruction for selecting the first payment method for a second order by the target user.

In some embodiments, the third instruction is sent based on a second selection page. For example, for the second selection page, references can be made to a page in a left half of FIG. 11A. In addition, it is worthwhile to note that, for descriptions of this step, references can be made to related descriptions in the above-mentioned embodiments.

Step S1504: The merchant client device sends the payment request to the acquiring server by using the payment component, where the payment request carries the token for password-free payment.

For example, the payment request can be generated by the payment component. The token can be locally read by the merchant client device from the login account of the target user in the merchant in an association manner, or can be obtained by the merchant client device from the merchant server, or the token is written by the merchant client device into the payment component. Therefore, the payment component can directly read the token, and include the token in the payment request.

Step S1506: The acquiring server sends a payment result for the second order to the merchant client device by using the payment component, where the payment result is obtained by the acquiring server by interacting with the serving party of the first wallet based on the payment request.

For descriptions of this step, references can be made to the above-mentioned related descriptions (for example, the processing result corresponding to the service request that includes at least the payment request is obtained).

Further, the merchant client device can display the received payment result on a second payment result page. For example, the second payment result page is a next page of the second selection page. For switching between the second payment result page and the second selection page, references can be made to FIG. 11A.

According to some embodiments of still another aspect, when the user chooses not to enable password-free payment, or when enabling of password-free payment fails, the user can be recommended to enable biometric identity verification, to facilitate subsequent quick payment. FIG. 16 is a schematic diagram illustrating a multi-party interaction process of enabling biometric identity verification, according to some embodiments of this specification. The interaction process includes the following steps.

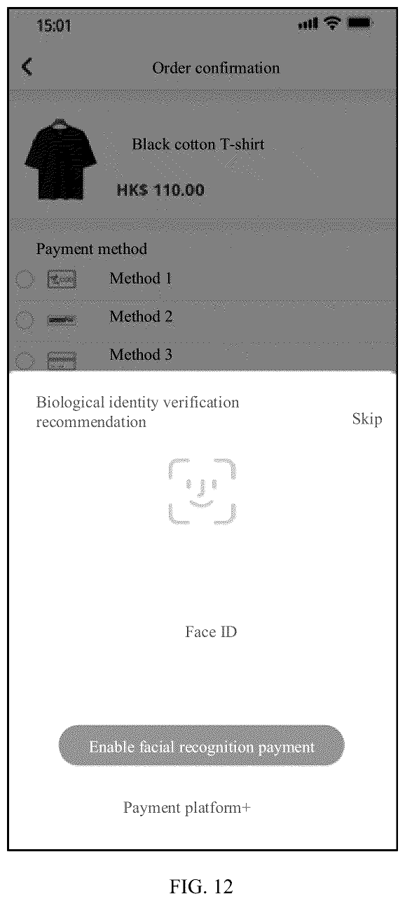

Step S1601: The merchant client device invokes the payment component, to obtain a recommendation page of the first wallet for biometric identity verification payment. For example, references can be made to the recommendation page shown in FIG. 12.

Step S1603: The merchant client device receives a subscription instruction initiated by the target user for biometric identity verification payment on the recommendation page and entered biometric identity verification information. It is worthwhile to note that, for descriptions of this step, references can be made to related description in the above-mentioned embodiments. Details are omitted.

Step S1605: The merchant client device sends a biometric identity verification subscription request to the acquiring server by using the payment component. For example, the biometric identity verification subscription request includes the biometric identity verification information entered by the target user based on the recommendation page.

Step S1607: The acquiring server sends a subscription result for biometric identity verification to the merchant client device by using the payment component, where the subscription result is obtained by the acquiring server by interacting with the serving party of the first wallet based on the biometric identity verification subscription request.

It is worthwhile to note that, there are a plurality of manners in which the acquiring server interacts with the serving party of the first wallet to obtain the subscription result. The manners can be designed based on a need. For example, the acquiring server can send the biometric identity verification subscription request to the server of the first wallet, so that the server processes the biometric identity verification subscription request and feeds back the corresponding subscription result.

The subscription result indicates that enabling of biometric identity verification succeeds or fails. In some embodiments, the acquiring server further sends, to the merchant client device by using the payment component, a token issued by the first wallet for biometric identity verification. It should be understood that the token is issued when enabling of biometric identity verification succeeds.

A case in which the user chooses to enable biometric identity verification is described above. It should be understood that the user can alternatively choose not to enable biometric identity verification.

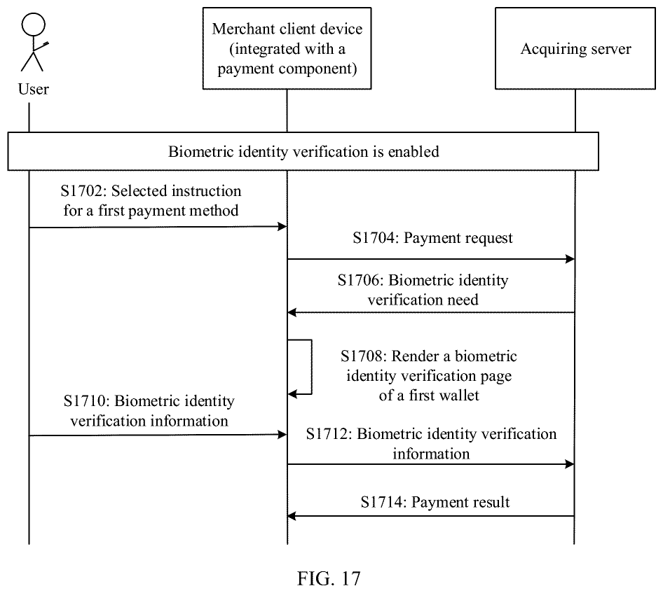

Further, when the user successfully enables biometric identity verification, the user can subsequently perform payment in a biometric identity verification manner. FIG. 17 is a schematic diagram illustrating a multi-party interaction process of performing payment after biometric identity verification is enabled, according to some embodiments of this specification. As shown in FIG. 17, the multi-party interaction process includes the following steps.

Step S1702: The merchant client device receives a fourth instruction for selecting the first payment method for a third order by the target user.

The fourth instruction is sent based on a third selection page. For example, for the third selection page, references can be made to the leftmost page in FIG. 13A. In addition, it is worthwhile to note that, for descriptions of this step, references can be made to related descriptions in the above-mentioned embodiments.

Step S1704: The merchant client device sends a payment request to the acquiring server by using the payment component. For example, the payment request includes a token for biometric identity verification.

Step S1706: The acquiring server sends a biometric identity verification need to the merchant client device by using the payment component, where the biometric identity verification need is obtained by the acquiring server by interacting with the serving party of the first wallet based on the payment request.

Step S1708: The merchant client device invokes the payment component based on the identity verification need, to obtain a biometric identity verification page of the first wallet. For example, for the biometric identity verification page, references can be made to the second page in three pages shown in FIG. 13A.

Step S1710: The merchant client device receives biometric identity verification information entered by the target user on the biometric identity verification page.

Step S1712: The merchant client device sends the biometric identity verification information to the acquiring server by using the payment component.

Step S1714: The acquiring server sends a payment result for the third order to the merchant client device by using the payment component, where the payment result is obtained by the acquiring server by interacting with the serving party of the first wallet based on the second payment request and the biometric identity verification information.

The multi-party interaction process related to secondary payment after the user successfully enables biometric identity verification is described above.

In conclusion, the payment request processing method disclosed in the some embodiments of this specification, a better payment service can be provided for the user, to create extremely simple and secure user experience.

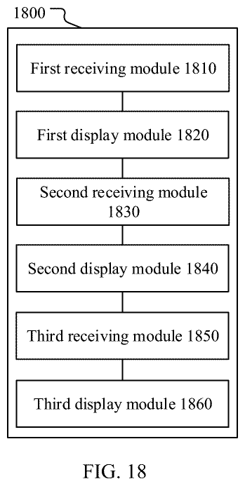

Corresponding to the payment method and the payment request processing method, some embodiments of this specification further disclose a payment apparatus and a payment request processing apparatus. Specifically, FIG. 18 is a schematic structural diagram illustrating a payment apparatus 1800, according to some embodiments of this specification. The payment apparatus is integrated into a merchant client device. As shown in FIG. 18, the payment apparatus 1800 includes: a first receiving module 1810, configured to receive a first instruction for selecting a first payment method for a first order on a first selection page by a target user, where the target user logs in to the merchant client device by using a first account; a first display module 1820, configured to display, in an interface of the merchant client device, an account confirmation page of a first wallet corresponding to the first payment method, where the first account is not a login account of the first wallet; a second receiving module 1830, configured to receive a confirmation instruction sent by the target user based on the account confirmation page; a second display module 1840, configured to display a checkout page of the first wallet in the interface of the merchant client device; a third receiving module 1850, configured to receive identity verification information entered by the target user based on the checkout page and a second instruction sent to instruct whether to subscribe to password-free payment; and a third display module 1860, configured to display a first payment result page, where the first payment result page includes at least a payment result corresponding to the first order.

In some embodiments, the merchant client device is installed in a target device, and an application client device of the first wallet is not installed in the target device.

In some embodiments, the account confirmation page and the checkout page are displayed in the interface of the merchant client device in a half page form by using a pop-up window or a floating layer.

In some embodiments, the account confirmation page and the checkout page each include a name and a design logo of the first wallet.

In some embodiments, the first display module 1820 is specifically configured to: display a pre-collected payment account of the first wallet on the account confirmation page; or display an account input box for the first wallet on the account confirmation page, to receive a payment account entered by the user based on the account input box.

In some embodiments, the payment apparatus 1800 further includes: a fourth display module, configured to display a secondary confirmation interface of the first wallet in the interface of the merchant client device; and a fourth receiving module, configured to receive identity verification information entered by the user based on the secondary confirmation interface, where an identity verification manner corresponding to the secondary confirmation interface is different from an identity verification manner corresponding to the checkout page.

In some embodiments, the second instruction instructs to subscribe to password-free payment, and the first payment result page further includes a subscription result for password-free payment.

In some specific embodiments, the subscription result indicates that subscription succeeds; and the payment apparatus 1800 further includes: a fifth receiving module, configured to receive a third instruction for selecting the first payment method for a second order on a second selection page by the target user; and a sixth receiving module, configured to display a second payment result page, where the second payment result page includes a payment result for the second order.

In some more specific embodiments, the second payment result page is a next display page of the second selection page.

In some other more specific embodiments, the second selection page includes a first selection area, the first payment method and a payment account of the first wallet are indicated in the first selection area, and the third instruction is sent by performing a triggering operation on the first selection area.

Further, in an example, the apparatus further includes: a sixth display module, configured to display a secondary confirmation interface of the first wallet in the interface of the merchant client device, where the secondary confirmation interface includes a to-be-paid amount corresponding to the second order, and the to-be-paid amount is greater than a corresponding threshold; and a sixth receiving module, configured to receive a payment confirmation operation sent by the target user based on the secondary confirmation interface.

In some embodiments, the second instruction instructs not to subscribe to password-free payment; and the apparatus further includes: a seventh display module, configured to display, in the interface of the merchant client device, a recommendation page of the first wallet for biometric identity verification payment; a seventh receiving module, configured to receive a subscription instruction initiated by the user for biometric identity verification payment based on the recommendation page and biometric identity verification information; and an eighth display module, configured to display a subscription result page for biometric identity verification payment.

In some specific embodiments, it is indicated on the subscription result page that a subscription to biometric identity verification payment succeeds; and the apparatus further includes: a ninth display module, configured to receive a fourth instruction for selecting the first payment method for a third order on a third selection page by the target user; an eighth receiving module, configured to: display a biometric identity verification page of the first wallet in the interface of the merchant client device, and receive the biometric identity verification information entered by the user based on the biometric identity verification page; and a tenth display module, configured to display a third payment result page, where the third payment result page includes a payment result for the third order.

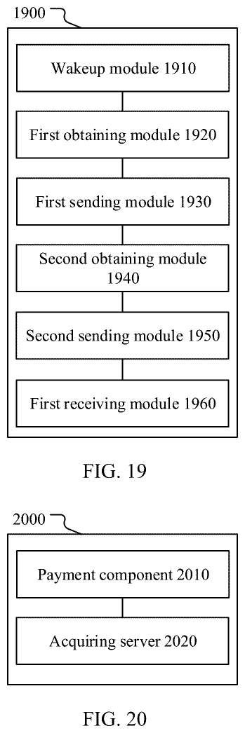

FIG. 19 is a schematic structural diagram illustrating a payment request processing apparatus 1900, according to some embodiments of this specification. The processing apparatus is integrated into a merchant client device. As shown in FIG. 19, the processing apparatus 1900 includes: a wakeup module 1910, configured to wake up, based on a first instruction for selecting a first payment method for a first order by a target user, a payment component integrated into the merchant client device, where the payment component is provided by an acquiring institution; a first obtaining module 1920, configured to invoke the payment component to obtain an account confirmation page of a first wallet corresponding to the first payment method; a first sending module 1930, configured to: send, by using the payment component, an order placement request to an acquiring server of the acquiring institution based on a confirmation instruction sent by the target user based on the account confirmation page, and receive a fed-back order placement completion notification; a second obtaining module 1940, configured to invoke the payment component based on the order placement completion notification, to obtain a checkout page of the first wallet; a second sending module 1950, configured to send, by using the payment component, the service request to the acquiring server based on the identity verification information entered by the target user on the checkout page and a second instruction sent to instruct whether to subscribe to password-free payment; and a first receiving module 1960, configured to receive a fed-back processing result, where the processing result includes at least a payment result for the first order.

In some embodiments, the second instruction instructs to subscribe to password-free payment, the service request includes a payment request and a subscription request, the processing result further includes a subscription success result, and the method further includes: obtaining a token issued by the first wallet for password-free payment.

In some specific embodiments, the apparatus further includes: a third sending module, configured to send, by using the payment component, the payment request to the acquiring server based on a third instruction for selecting the first payment method for a second order by the target user; and a second receiving module, configured to receive a fed-back payment result, where the payment request carries the token.

In some embodiments, the second instruction instructs not to subscribe to password-free payment, and the service request includes a payment request.

In some specific embodiments, the apparatus further includes: a second obtaining module, configured to invoke the payment component, to obtain a recommendation page of the first wallet for biometric identity verification payment; and a fourth sending module, configured to send, by using the payment component, a biometric identity verification subscription request to the acquiring server based on a subscription instruction initiated by the target user for biometric identity verification payment on the recommendation page and entered biometric identity verification information; and a third receiving module, configured to receive a fed-back subscription result.

In some specific embodiments, the subscription result indicates that a subscription to biometric identity verification payment succeeds; and the apparatus further includes: a fifth sending module, configured to: send, by using the payment component, a payment request to the acquiring server based on a fourth instruction for selecting the first payment method for a third order by the target user, and receive a fed-back identity verification need; a third obtaining module, configured to invoke the payment component based on the identity verification need, to obtain a biometric identity verification page of the first wallet; a sixth sending module, configured to send, to the acquiring server by using the payment component, the biometric identity verification information entered by the target user on the biometric identity verification page; and a fourth receiving module, configured to receive a returned payment result.

According to some embodiments of yet another aspect, some embodiments of this specification further disclose an acquiring system. FIG. 20 is a schematic structural diagram illustrating an acquiring system 2000, according to some embodiments of this specification. The acquiring system 2000 includes a payment component 2010 and an acquiring server 2020, and the payment component is integrated into a merchant client device. It should be understood that the acquiring server 2020 can be a set of any quantity of servers, and is usually a cluster.

The payment component 2010 is configured to provide an account confirmation page of a first wallet corresponding to a first payment method in response to a first instruction in the merchant client device. The first instruction is an instruction for selecting the first payment method for a first order by a target user. The payment component 2010 is further configured to send an order placement request to the acquiring server 2020 in response to a confirmation instruction sent by the target user based on the account confirmation page. The acquiring server 2020 is configured to: interact with a serving party of the first wallet based on the order placement request, to obtain an order placement completion notification, and forward the order placement completion notification to the merchant client device by using the payment component 2010, so that the merchant client device displays a checkout page of the first wallet. The payment component 2010 is further configured to send the service request to the acquiring server 2020 in response to the identity verification information entered by the target user on the checkout page and a second instruction sent to instruct whether to subscribe to password-free payment. The acquiring server 2020 is further configured to: interact with the serving party of the first wallet based on the service request, to obtain a processing result, and forward the processing result to the merchant client device by using the payment component 2010. The processing result includes at least a payment result for the first order.

In some embodiments, the second instruction instructs to subscribe to password-free payment, the service request includes a payment request and a subscription request, the processing result further includes a subscription success result, and the method further includes: The acquiring server 2020 forwards, to the merchant client device, a token issued by the first wallet for password-free payment.

In some embodiments, the payment component 2010 is further configured to: send the payment request to the acquiring server 2020 in response to a third instruction in the merchant client device, and receive a fed-back payment result. The third instruction is an instruction for selecting the first payment method for a second order by the target user, and the payment request carries the token.

In some embodiments, the second instruction instructs not to subscribe to password-free payment, and the service request includes a payment request.

In some specific embodiments, the payment component 2010 is further configured to provide a recommendation page of the first wallet for biometric identity verification payment; the payment component 2010 is further configured to send a biometric identity verification subscription request to the acquiring server 2020 in response to a subscription instruction initiated by the target user for biometric identity verification payment on the recommendation page and entered first biometric identity verification information; and the acquiring server 2020 is further configured to: interact with the serving party of the first wallet based on the biometric identity verification subscription request, to obtain a subscription result, and forward the subscription result to the merchant client device by using the payment component 2010.

In some specific embodiments, the subscription result indicates that a subscription to biometric identity verification payment succeeds.

The payment component 2010 is further configured to: send a payment request to the acquiring server 2020 in response to a fourth instruction in the merchant client device, and obtain a fed-back identity verification need. The fourth instruction is an instruction for selecting the first payment method for a third order by the target user. The payment component 2010 is further configured to: provide a biometric identity verification page of the first wallet based on the identity verification need, and send, to the acquiring server 2020, second identity verification information entered by the target user on the biometric identity verification page. The acquiring server 2020 is further configured to: interact with the serving party of the first wallet based on the second biometric identity verification information, to obtain a payment result, and forward the payment result to the merchant client device by using the payment component 2010.

According to some embodiments of a still yet another aspect, a computer-readable storage medium is further provided. The computer-readable storage medium stores a computer program, and when the computer program is executed in a computer, the computer is enabled to perform the method described with reference to FIG. 5, FIG. 14, FIG. 15, FIG. 16, or FIG. 17.

According to some embodiments of a further aspect, a computing device is further provided, including a memory and a processor. The memory stores executable code, and the processor executes the executable code, to implement the method described with reference to FIG. 5, FIG. 14, FIG. 15, FIG. 16, or FIG. 17. A person skilled in the art should be aware that in the one or more examples, functions described in this application may be implemented by hardware, software, firmware, or any combination thereof. When the functions are implemented by software, the functions can be stored in a computer-readable medium or transmitted as one or more instructions or code on the computer-readable medium.

Specific implementations described above further describe the purposes, technical solutions, and beneficial effects of this application. It should be understood that the above-mentioned descriptions are merely some specific implementations of this application and are not intended to limit the protection scope of this application. Any modification, equivalent replacement, or improvement made based on the technical solutions of this application shall fall within the protection scope of this application.

What is claimed is:

1. A computer-implemented method for payment, comprising:
receiving a first instruction for selecting a first payment method for a first order on a first selection page by a target user;
displaying, in an interface of a merchant client device, an account confirmation page of a first wallet corresponding to the first payment method;
receiving a confirmation instruction sent by the target user based on the account confirmation page;
displaying a checkout page of the first wallet in the interface of the merchant client device;
receiving identity verification information entered by the target user based on the checkout page; and
displaying a first payment result page, wherein the first payment result page comprises at least a payment result corresponding to the first order.

2. The computer-implemented method of claim 1, wherein the merchant client device is installed in a target device, and an application client device of the first wallet is not installed in the target device.

3. The computer-implemented method of claim 1, wherein the account confirmation page and the checkout page are displayed in the interface of the merchant client device in a half page form by using a pop-up window or a floating layer.

4. The computer-implemented method of claim 1, wherein the account confirmation page and the checkout page each comprise a name and a design logo of the first wallet.

5. The computer-implemented method of claim 1, wherein, using a first account, the merchant client device is logged into by the target user, and wherein the first account is not a login account of the first wallet.

6. The computer-implemented method of claim 1, wherein displaying, in an interface of a merchant client device, an account confirmation page of a first wallet corresponding to the first payment method, comprises:
displaying a pre-collected payment account of the first wallet on the account confirmation page; or
displaying an account input box for the first wallet on the account confirmation page, to receive a payment account entered by the target user based on the account input box.

7. The computer-implemented method of claim 1, comprising:
after receiving identity verification information entered by the target user based on the checkout page and before displaying a first payment result page:
displaying a secondary confirmation interface of the first wallet in the interface of the merchant client device; and
receiving identity verification information entered by the target user based on the secondary confirmation interface, wherein an identity verification manner corresponding to the secondary confirmation interface is different from an identity verification manner corresponding to the checkout page.

8. The computer-implemented method of claim 1, comprising:
receiving a second instruction sent by the target user based on the checkout page to instruct whether to subscribe to password-free payment.

9. The computer-implemented method of claim 8, wherein:
the second instruction instructs to subscribe to password-free payment; and
the first payment result page comprises a subscription result for password-free payment.

10. The computer-implemented method of claim 9, wherein:
the subscription result indicates that subscription succeeds; and
after the displaying a first payment result page:
receiving a third instruction for selecting the first payment method for a second order on a second selection page by the target user; and
displaying a second payment result page, wherein the second payment result page comprises a payment result for the second order.

11. The computer-implemented method of claim 10, wherein the second payment result page is a next display page of the second selection page.

12. The computer-implemented method of claim 10, wherein the second selection page comprises a first selection area, the first payment method and a payment account of the first wallet are indicated in the first selection area, and the third instruction is sent by performing a triggering operation on the first selection area.

13. The computer-implemented method of claim 11, wherein, after receiving a third instruction and before displaying a second payment result page:
displaying a secondary confirmation interface of the first wallet in the interface of the merchant client device, wherein the secondary confirmation interface comprises a to-be-paid amount corresponding to the second order, and the to-be-paid amount is greater than a corresponding threshold; and
receiving a payment confirmation operation sent by the target user based on the secondary confirmation interface.

14. The computer-implemented method of claim 8, wherein:
the second instruction instructs not to subscribe to password-free payment; and
after the displaying a first payment result page:
displaying, in the interface of the merchant client device, a recommendation page of the first wallet for biometric identity verification payment;
receiving a subscription instruction initiated by the target user for biometric identity verification payment based on the recommendation page and biometric identity verification information; and
displaying a subscription result page for biometric identity verification payment.

15. The computer-implemented method of claim 14, wherein:
it is indicated on the subscription result page that a subscription to biometric identity verification payment succeeds.

16. The computer-implemented method of claim 15, comprising:
after the displaying a subscription result page for biometric identity verification payment:
receiving a fourth instruction for selecting the first payment method for a third order on a third selection page by the target user.

17. The computer-implemented method of claim 16, comprising:
displaying a biometric identity verification page of the first wallet in the interface of the merchant client device, and receiving the biometric identity verification information entered by the target user based on the biometric identity verification page.

18. The computer-implemented method of claim 17, comprising:
displaying a third payment result page, wherein the third payment result page comprises a payment result for the third order.

19. A non-transitory, computer-readable medium storing one or more instructions executable by a computer system to perform one or more operations for payment, comprising:
receiving a first instruction for selecting a first payment method for a first order on a first selection page by a target user;
displaying, in an interface of a merchant client device, an account confirmation page of a first wallet corresponding to the first payment method;
receiving a confirmation instruction sent by the target user based on the account confirmation page;
displaying a checkout page of the first wallet in the interface of the merchant client device;
receiving identity verification information entered by the target user based on the checkout page; and
displaying a first payment result page, wherein the first payment result page comprises at least a payment result corresponding to the first order.

20. A computer-implemented system for payment, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving a first instruction for selecting a first payment method for a first order on a first selection page by a target user;
displaying, in an interface of a merchant client device, an account confirmation page of a first wallet corresponding to the first payment method;
receiving a confirmation instruction sent by the target user based on the account confirmation page;
displaying a checkout page of the first wallet in the interface of the merchant client device;
receiving identity verification information entered by the target user based on the checkout page; and
displaying a first payment result page, wherein the first payment result page comprises at least a payment result corresponding to the first order.
